(19) United States
(12) Patent Application Publication
(10) Pub. No.: US 2009/0233259 A1
(43) Pub. Date: Sep. 17, 2009

(54) Genetic portrait of a person

(76) Inventor: Evgeniy Podvorchan, Ladushkin (RU)

Correspondence Address: Aleksandr Smushkovich, POB 140505, Brooklyn, NY, 11214, US

(21) Appl. No.: 12/075,843

(22) Filed: Mar. 14, 2008

(51) Int. Cl. G09B 11/10

(52) U.S. Cl. 434/81

(57) ABSTRACT

A method for creation of a genetic portrait of at least one person is provided. The genetic portrait is capable of carrying both the image and genetic information about the person(s). The method comprises a step for producing an image portrait of the person(s) wherein the image portrait includes an image hair zone, a step for obtaining and conditioning hair of the person(s), and a step for preparation and attachment of the conditioned hair to the image hair zone. The attachment can be performed by several means, such as different kinds of glue, described in the specification. An optional step can be provided comprising an incorporating of predeterminedly treated genetic information items of the person(s) into the image portrait. Such genetic information items may include fragments of least one of the following: blood, skin, bone, nail, tooth, and soft tissue.

### FIELD OF INVENTION

The invention relates to the field of image creation arts, particularly to the creation of a portrait capable to carry genetic information of a person or persons depicted on the portrait.

### BACKGROUND OF THE INVENTION

Picturing portraits of persons is one of the ancient types of art that essentially obeys the purpose of saving an image of the pictured person for later generations of people, often the person's descendents. There have been a lot of techniques proposed for making such images, from cutting stones, burning wood, and other materials; drawing such image on paper with a pencil; painting it on canvases, walls, ceilings, floors; making a photo-image with subsequent painting or coloring its parts; to using modern digital photography and software editing. Obviously, all portraits made based on the above enumerated and many other known techniques don't carry genetic information pertaining to the person or persons depicted on the portrait.

On the other hand, there are known certain genetic-related technologies that allow preserving genetic information pertaining to persons. Some of them are based on the use of genetic materials, such as blood or hair of a person, in special banks for storage of the genetic materials. This may allow for recognition of the person's participation to historical events, for criminal investigation, for determination of relatives, for medical, and other purposes. However, none of the known genetic-related technologies encompasses a possibility to readily recognize an image of such person or persons, whose genetic information has been preserved.

### BRIEF DESCRIPTION OF THE INVENTION

The primary aim of this invention is to establish a method for creation of a portrait (herein called a ‘genetic portrait’) of a person or persons, which genetic portrait will carry both the image and genetic information about the person or persons. Other aims of the invention might become apparent to a person skilled in the art upon reading the present disclosure.

In a preferred embodiment of the inventive method, a first step of the method includes producing an image (i.e. traditional) portrait of a person (persons), also called herein ‘portrayed person(s)’ by any commonly known technique (e.g. described herein above), which portrait must include an image of the upper portions of the person's head (persons' heads), where the person's (persons') hair is (are) traditionally depicted. These portions are herein called a ‘hair zone’, and the first step may be called a ‘step for producing an image portrait of a person (persons)’. The hair zone can be pictured as a hair image as on a traditional portrait. Alternatively, the hair zone can be left blank, i.e. containing no image, or containing just a contour of the hair.

A second step of the inventive method is a special processing of the person's (persons') hair to condition them for durable preservation, which can be called a ‘step for obtaining and conditioning hair of the portrayed person (persons)’, and the so treated hair is called ‘conditioned hair’. Several types of such processing are known in the art, one of which is described herein further.

In optional embodiments, for most of the situations, the step for obtaining and conditioning hair of the portrayed person (persons) can be performed first, and the step for producing an image portrait of a person (persons) can be performed second, which does not substantially alter the inventive method.

A third step of the inventive method is a step for preparation and attachment of the conditioned hair to the hair zone of the image of the portrayed person (or to the hair zones of the image of the respective portrayed persons). The exemplary preparation and attachment techniques are described herein below. In some embodiments of the method, after the attachment of the hair, the hair zone can be covered with a protective layer to prolong the preservation of hair attached to the portrait.

In alternative embodiments, other types of the person's (persons') genetic information containing items can be incorporated into the genetic portrait. For example, the genetic portrait can be painted with a liquid solution containing blood (including a solution fully consisting of 100% blood) of the portrayed person (persons). Traditional tools (such as a brush, sponge, tampon, spay, sprinklers, fingers of the painter of the portrait, etc.) or non-traditional tools (such as a syringe or another type of injector) can be utilized for painting-the portrait on a canvass, or another suitable substrate.

Generally, the genetic portrait can comprise at least one of the following predeterminedly treated genetic information containing items of the portrayed person (persons): fragments of hair, blood, skin, bone, nail, teeth, soft tissue, or other fragments of the person (persons). Some techniques of the predetermined treatment of the genetic information containing items are taught, for example, on an Internet site: www.businesspravo.ru in an article “Methods for Control, Chemical Factors, Determination of Chemical Elements Contents in Diagnosed Bio-Substrates, Specimen, and Biological Additives by a Mass-Spectrometric Method with Induction-Linked Argon Plasma”.

The inventive method normally supposes that the portrayed person(s) voluntary render(s) his (her, their) genetic information containing items to the maker of the portrait, excluding emergency situations where such rendering is not feasible (e.g., the portrayed person is dead), or can be lawfully enforced, etcetera.

### DESCRIPTION OF AN EXAMPLARY EMBODIMENT OF THE INVENTION

While the invention may be susceptible to embodiment in different forms, there will be described in detail herein, specific exemplary embodiments of the present invention, with the understanding that the present disclosure is to be considered an exemplification of the principles of the invention, and is not intended to limit the invention to that as illustrated and described herein.

In an exemplary preferred embodiment, the method for creation of a genetic portrait of a person or persons comprises a step for producing an image portrait of at least one portrayed person by painting his (her, their) image on a canvass, in such a way that the portrait includes an image of his (her, their) hair zone.

In the exemplary preferred embodiment, the method for creation of a genetic portrait comprises a step for obtaining and conditioning hair of the at least one portrayed person as follows: the hair is cut preferably from the occipital area (rear portion of the head) at the full length of hair in the amount of at least 0.1 gram; for removal of the surface grease and fat, the sample hair preparation technique proposed by the International Atomic Energy Organization can be recommended, according to which, the hair is treated with acetone during 10-15 minutes, and then is rinsed three times with de-ionized water. The hair is dried during 10-15 minutes under a common room temperature.

In the exemplary preferred embodiment, the method for creation of a genetic portrait comprises a step for preparation and attachment of the conditioned hair to the hair zone of the image of the portrayed person(s) as follows: a strand of the obtained and conditioned hair (preferably containing from 10 to 40 single hairs) is treated with a glue compound. The strand can be covered by a suitable brush, tampon, sponge, or the like, impregnated with the glue compound up to a predetermined length (preferably, half of the strand's length), forming a glued end and a non-treated end. Alternatively, the strand can be submerged into the glue compound to a predetermined depth. The hair zone can preferably be also pre-treated by the glue compound.

The so prepared hair strand is applied to the hair zone with its glued end, and, after the drying up, is attached thereto due to the adhesive property of the glue compound. The strand can be applied manually, or optionally suitable implements can be employed. The drying time differs for various compounds, and is typically indicated in instructions to them. The hair zone is covered with a necessary number of such strands, until the entire hair zone or a predetermined portion thereof is filled with hair attached thereto.

Then the hair zone can be optionally after-treated by covering it with a protective layer, preferably containing the glue compound, and/or with a protective layer painted over and containing a suitable kind of stain. This optional step can be called a ‘step for covering the hair zone with a protective layer’.

Good results were attained with the use of the following sorts of glue: Makroflex SX 101. Henkel Makroflex LTD. PL7, Oitti, Finland www.makroflex.com; wood polish “Rastsvet” ZAO Empils-Russia 344010, Rostov-na-Donu, pr. Teatralniy 60; polymer universal glue “Sniezka SA”, Poland, 39-102 Lubzina 34A, Dzial Handlowy: 39-207 Brzeznica 18. www.przemaluj.pl; poly-vinyl-acetate glue “Moment-Stolyar” OAO ‘Khenkel-ERA’ Russia 187000, Leningrad oblast, town of Tosno, Moskovskoye Shosse 1, www.moment.ru; hair spray “Taft Power”-OAO ‘Arnest’, Russia 357107, Stavropol kray, city of Nevinomissk, ul. Kombinatnaya 6, www.schwarzkopf.ru.

However, other poly-vinyl-acetate and polymer glues, silicon (e.g. sanitary colorless silicon), liquid hairsprays, wood polishes, etc. can be tried as well. The mentioned compounds are essentially made based on alkyd or acrylic resins and silicon, and normally do not negatively affect the structure of hair. Just opposite, after the solvent, contained in the compound, is dried up, the compound creates a synthetic protective film covering the hair that can prolong its preservation time-span.

In conclusion, according to the description, it can be noted that all of the disclosed embodiments and steps of the inventive methods can be implemented by those skilled in the art through the use of conventionally known materials and techniques, without undue experimentation.

I claim:

1. A method for creation of a genetic portrait of at least one person, said genetic portrait capable of carrying both the image and genetic information about the at least one person, said method comprising:
a step for producing an image portrait of said at least one person, said image portrait including an image hair zone;
a step for obtaining and conditioning hair of said at least one person; and
a step for preparation and attachment of the conditioned hair to the image hair zone.

2. The method according to claim 1, wherein after the step for preparation and attachment of the conditioned hair to the image hair zone, said method further comprising a step for covering the hair zone with a protective layer.

3. A method for creation of a genetic portrait of at least one person, said genetic portrait capable of carrying both the image and genetic information about the at least one person, said method comprising:
a step of producing the genetic portrait of said at least one person by painting said genetic portrait on a canvass with a liquid solution containing blood of said at least one person.

4. The method according to claim 3, wherein said liquid solution fully consisting of blood of said at least one person.

5. A method for creation of a genetic portrait of at least one person, said genetic portrait capable of carrying both the image and genetic information about the at least one person, said method comprising:
a step for producing an image portrait of said at least one person, said image portrait including an image hair zone;
a step for obtaining and conditioning hair of said at least one person;
a step for preparation and attachment of the conditioned hair to the image hair zone; and
a step of incorporating into said image portrait predeterminedly treated genetic information containing items of said at least one person, said items including fragments of least one of the following: blood, skin, bone, nail, tooth, and soft tissue.
